(19) United States
(12) Patent Application Publication
(10) Pub. No.: US 2014/0165869 A1
(43) Pub. Date: Jun. 19, 2014

(54) Adaptable Steering Assembly for Tool Head for Use in a Pipeline

(71) Applicant: Shaun M. Flanery, Ottawa, IL (US)

(72) Inventor: Shaun M. Flanery, Ottawa, IL (US)

(21) Appl. No.: 13/916,418

(22) Filed: Jun. 12, 2013

Related U.S. Application Data
(60) Provisional application No. 61/660,769, filed on Jun. 17, 2012.
(60) Provisional application No. 61/668,551, filed on Jul. 6, 2012.

(51) Int. Cl. F16L 55/26; F16L 55/30; F16L 55/40

(52) U.S. Cl. CPC F16L 55/265; F16L 55/40; F16L 55/30
USPC 104/138.2

(57) ABSTRACT

A steering assembly for use in a pipeline is disclosed. A skid is moveable along an axial pathway. A cable-receiving member is mounted to the skid. A shoe member is rotationally secured to the cable-receiving member. An extension module is moveable upward away from the skid. A hose can pass through the cable-receiving terminus, the shoe member and the extension module, and a hose-mounted tool head is rotationally and upwardly movable relative to the skid.

### CROSS REFERENCE TO RELATED APPLICATIONS

This application claims priority to U.S. provisional patent application Ser. No. 61/660,769, filed Jun. 17, 2012, and to U.S. provisional patent application Ser. No. 61/668,551, filed Jul. 6, 2012.

### FIELD OF THE INVENTION

An adaptable steering assembly for a tool head for use in a pipeline is disclosed. The tool head can include a jet hose head, cutter head, inspection camera head, push rod, sonde, etc. In a preferred embodiment, the adaptable steering assembly is constructed and arranged to permit guidance of the tool head to the joinder of two pipes while at the same time permitting a single assembly to be adaptable to different diameter pipes.

In a more preferred embodiment, the apparatus provides a superior assembly for use in cleaning, maintaining, inspecting and/or locating residential and business sewer lines via access not from the residence or business, but rather from the sewer main. Unlike conventional apparatus adapted for use in this fashion, the adaptable steering assembly is constructed and arranged to be adaptable to sewer mains of differing inner diameters, through adjustment of the assembly to accommodate the necessary parts to accomplish the task at hand.

In a most preferred embodiment, an optional laser sight is incorporated to provide even more precise locating functionality.

The apparatus thus disclosed permits precise insertion of a jet hose, cutting and/or inspection head into a lateral connection (e.g. minor pipe) where the tool head is a greater length than the inner diameter of the lateral connection. In one example, a 6-inch long tool head can now be guided along a major pipe and turned to travel along a 4-inch lateral connection.

### BACKGROUND OF THE INVENTION

There is need for an adaptable steering assembly for a tool head for use in a pipeline that can provide a combination of features facilitating convenient adaptation in the field with maximum adaptability to a plurality of pipe diameters. Previously, there have been devices adaptable to use in obtaining steerable access to a minor pipe (e.g. residential or business sewer line, or any trunk line) via access through a major pipe (e.g. municipal sewer line or any branch line) to which the minor pipe joins. However, these fail to provide the features and advantages of the instant disclosure.

In a conventional system, a skid-mounted unit is assembled including cameras, cutters, and the like and positioned in the major pipe proximate to the junction with the minor pipe. The tool head, e.g. a jet hose, is positioned through a curved piece of PVC conduit that is oriented in an upwardly extending fashion relative to the skid, and a water stream is furnished to the jet hose head and forced substantially radially symmetrically outwardly through the jet head. As the jet hose is positioned toward the junction of the major and minor pipe, the water stream pushes the jet hose toward the minor pipe opening, whereupon the operator must attempt to guide the jet hose into the minor pipe. In this example, the user may be limited by the size of the PVC conduit or rigid tray.

The conventional system as described is generally sized to fit a single diameter of major pipe for a particular construction of tool head. Accordingly, different sizes of components must be assembled, and adaptability is limited.

A problem associated with such devices that precede the present disclosure is that they do not provide, in combination with the other features and advantages disclosed herein, an adaptable steering assembly for a tool head for use in a pipeline that fits a broad range of pipe diameters.

There is a demand, therefore, to overcome the foregoing problems while at the same time providing an adaptable steering assembly for a tool head for use in a pipeline that is adaptable to a multiplicity of uses and that is also relatively low in cost to manufacture and yet possesses extended durability.

### SUMMARY OF THE INVENTION

In a preferred embodiment, an adaptable steering assembly for a tool head for use in a pipeline is disclosed.

An object of the present disclosure is to provide, in combination with the other features and advantages disclosed herein, an adaptable steering assembly for a tool head for use in a pipeline that can be fitted to a broad range of pipe diameters, thereby providing maximum adaptability in the field.

Another object of the present disclosure is to provide, in combination with the other features and advantages disclosed herein, an adaptable steering assembly for a tool head for use in a pipeline that facilitates turning a tool head so that it travels from a mainline pipe to a lateral pipe.

Another object of the present disclosure is to provide, in combination with the other features and advantages disclosed herein, an adaptable steering assembly for a tool head for use in a pipeline that is steerable yet at the same time includes see-through surfaces on the necessary components thereof so as to permit continuous and uninterrupted line-of-sight during the steering operation and thereafter.

The following disclosure provides an adaptable steering assembly for a tool head for use in a pipeline that is adaptable to a multiplicity of uses while at the same time being relatively low in cost to manufacture and yet possessing extended durability.

### BRIEF DESCRIPTION OF THE DRAWINGS

In the detailed description that follows, reference will be made to the following figures:

FIG. 1 is a top plan perspective view of a portion of a preferred embodiment;

FIG. 2 is a perspective view of a portion of a preferred embodiment;

FIG. 3 is a perspective view of an exploded view of a portion of a preferred embodiment;

FIG. 4 is a perspective view of an alternate embodiment;

FIG. 5 is a perspective cutaway view of a laser sight mounted on the steering assembly hardware as located at the junction of a major and minor pipeline;

FIG. 6 is another perspective cutaway view of a laser sight mounted on the steering assembly hardware;

FIG. 7 is still another view of the laser sight mounted on the steering assembly hardware; and

FIG. 8 is a schematic representation of a laser sight array constructed and arranged to verify position and pipe size.

### DETAILED DESCRIPTION OF PREFERRED EMBODIMENTS

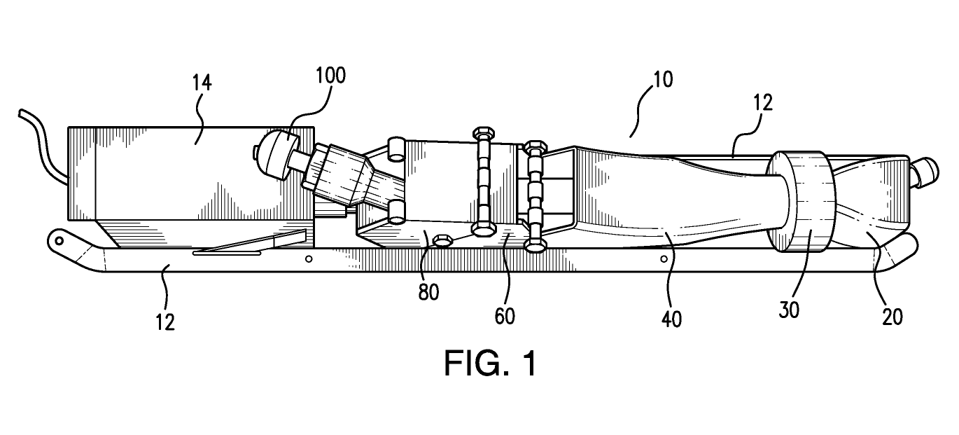

Referring now to FIGS. 1 through 3, a preferred embodiment is disclosed. As shown in FIG. 1, an adaptable assembly for a tool head for use in a pipeline 10 is mounted on a skid 12. A motor 14 is provided so that the assembly 10 can be rotated as necessary to align with a minor pipe extending from a major pipe.

Referring still to FIG. 1, a cable funnel 20 is provided to gather the hose, communication cables and other items to be strung through the pipe. The cable funnel is fixed in rotational orientation, that is, it does not rotate to any meaningful degree relative to the skid 12. The cable funnel 20 communicates with an articulating junction 30 constructed and arranged to provide rotational securement of a primary shoe 40 with the cable funnel 20 so that the primary shoe 40 can be rotated but remains in fluid communication with the cable funnel 20.

A first extension module 60 is provided and, as illustrated, a last extension module 80 is provided, as well. As configured, it is anticipated that as few as zero or one first extension modules 60 could be used, and as many as six first extension modules 60 could be used, although this understanding is formative and should not be limiting. The tool head 100 is positioned beyond the terminus of the last extension module 80 to be used and lays flat in the major pipeline until it reaches a position proximate to the minor pipeline junction.

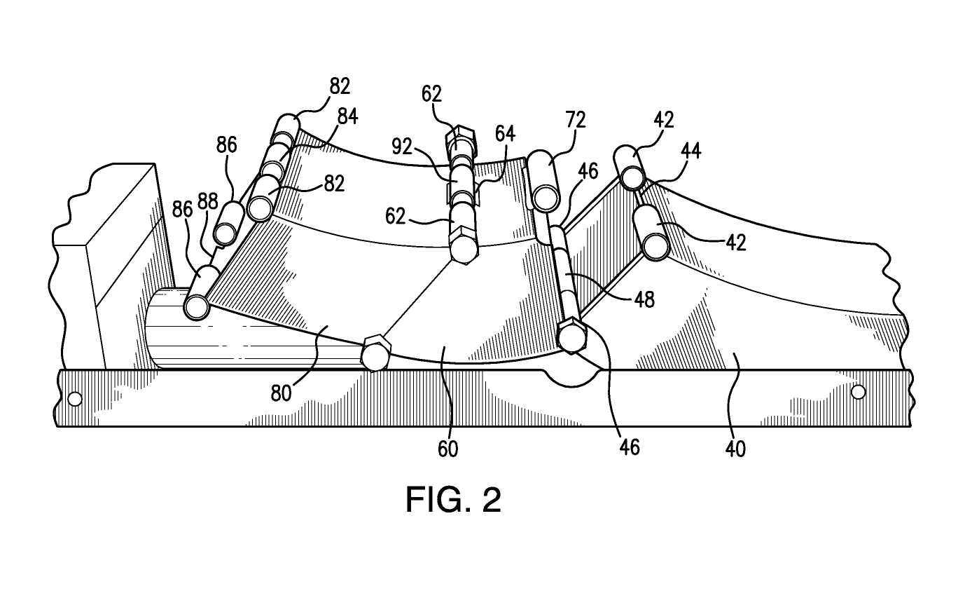

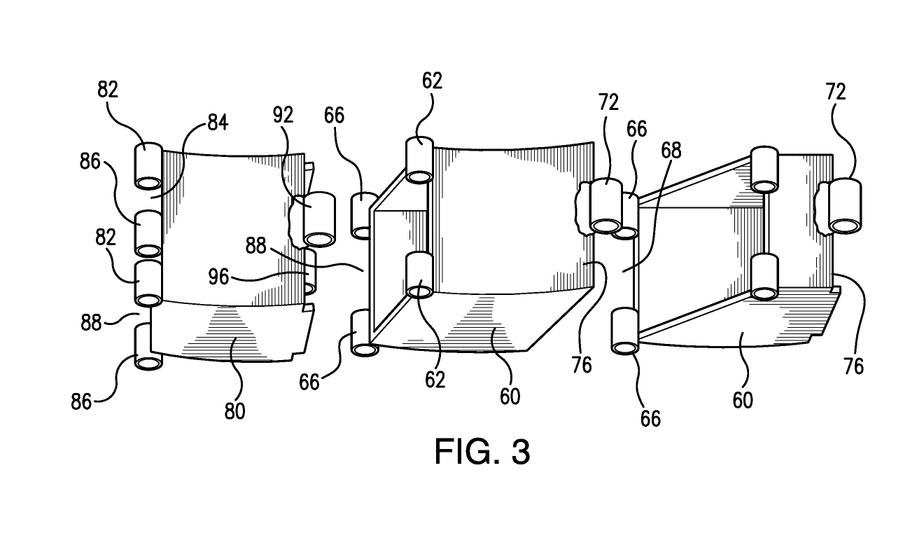

Referring now to FIGS. 2 and 3, the primary shoe 40 is provided with two forward top bolt apertures 42 spaced at the forward top portion of the shoe 40 and spaced apart to provide a forward top bolt aperture spacer 44. Two forward bottom bolt apertures 46 are provided and likewise spaced apart to provide a forward bottom bolt aperture spacer 48.

In similar fashion, the first extension module 60 is provided with two forward top bolt apertures 62 spaced at the forward top portion of the module 60 and spaced apart to provide a forward top bolt aperture spacer 64. Two forward bottom bolt apertures 66 are provided (see FIG. 3) and likewise spaced apart to provide a forward bottom bolt aperture spacer 68. Additionally, the first extension module is provided with a single rearward top bolt aperture 72 and a single rearward bottom bolt aperture 76, configured for communication with the primary shoe 40.

Likewise, the last extension module 80 is provided with two forward top bolt apertures 82 spaced at the forward top portion of the module 80 and spaced apart to provide a forward top bolt aperture spacer 84. Two forward bottom bolt apertures 86 are provided and likewise spaced apart to provide a forward bottom bolt aperture spacer 88. Additionally, the last extension module is provided with a single rearward top bolt aperture 92 and a single rearward bottom bolt aperture 96, configured for communication with the first extension module.

The bolt aperture for the last extension module used can optionally provide a slot configured to receive a roller on the back and front (not shown in FIG. 1 but locatable at 92 and 82, shown in FIGS. 2 and 3).

As assembled, the modules are positioned so that the bolt apertures communicate with the spacers, thereby interlocking the pieces in a lateral direction and defining a bolt-receiving passageway configured to receive a bolt. The bolts are secured by nuts. Of particular usefulness is that, on the last module to be used, the top bolt apertures are provided not only with a bolt, but with a collar overlaying the bolt and positioned within the aperture spacer. This collar may be located at aperture spacer 84. The bolt and/or the collar can act as a friction reducing pivot member so that the hose can pivot outwardly around the bold/collar assembly, rather than impinging upon the junction of the minor pipe and the major pipe. Additionally, rollers may be provided on the top and bottom to reduce friction, as well.

Note that, in use, the top of at least one of the modular extensions is not bolted to the successive modular extension. This permits the unit to “lie down” and travel more freely through the major pipe. The tool head 100, which in this case comprises a jet hose head, is positioned in the major pipe. Once the minor pipe is reached, the pressure from the jet hose head will lift the assembly upward, permitting a pivoting action upward until the bolt apertures reach the vicinity of the successive spacer. It has been found that this works best if either the primary shoe is not bolted at the top to the first modular extension, or if the first modular extension is not bolted at the top to the second modular extension.

The motor 14 provides rotational movement so that the device can be steered. This is necessary to facilitate alignment of the apparatus with the minor pipe extending from the major pipe, as these do not always extend vertically from the major pipe.

Another feature, not shown in the drawings, is that a portion of a module wall may be made of glass, clear plastic or any other suitable material so that they can be see-through. This is most useful on the bottom and top surface of each module. Thus, as extended, a camera can still see the tool head position. Without providing the clear material for the top and bottom wall, sight of the tool head from the major pipe perspective would be lost.

It is anticipated that a single, smaller apparatus could be sized to work well with major pipes having an inner diameter of between about 2 inches to about 6 inches, and that a larger apparatus could be sized to work well with major pipes having an inner diameter of between about 8 inches to about 24 inches. Accordingly, the disclosure provides a superior assembly for use in cleaning, inspecting, maintaining and/or locating residential and business sewer lines via access not from the residence or business, but rather from the sewer main. Unlike conventional apparatus adapted for use in this fashion, the adaptable steering assembly for a tool head for use in a pipeline is constructed and arranged to be adaptable to sewer mains of differing inner diameters, through adjustment of the assembly to accommodate the necessary parts to accomplish the task at hand.

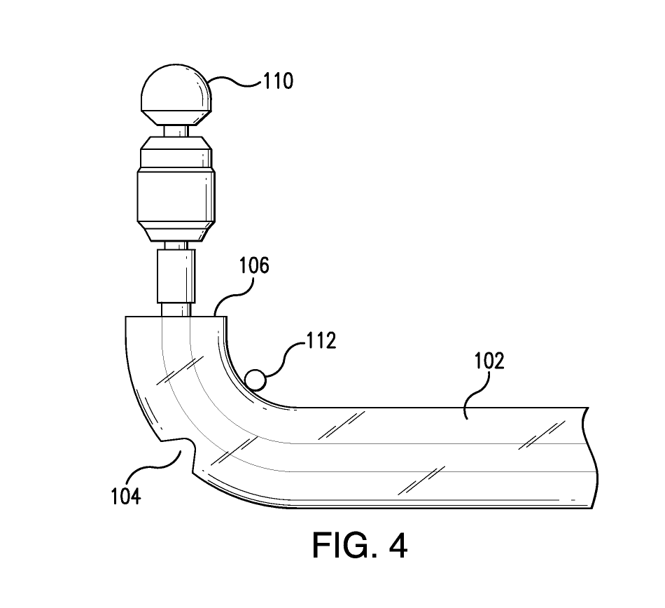

Referring now to FIG. 4, an alternative embodiment of the disclosure is illustrated. In this embodiment, a clear, flexible conduit or hose 102 is used in place of metal parts. The conduit 102 is flexible but is provided with a notch 104 made in the lower portion at a desired distance from the conduit terminus 106, which would facilitate an upward bending flex as the hose head 110 or jet nozzle reaches the junction of the minor pipe with the major pipe through which the assembly is traveling. For added stability and lowered friction, a pin 112 can be positioned opposite the notch 104 and secured to the conduit 102.

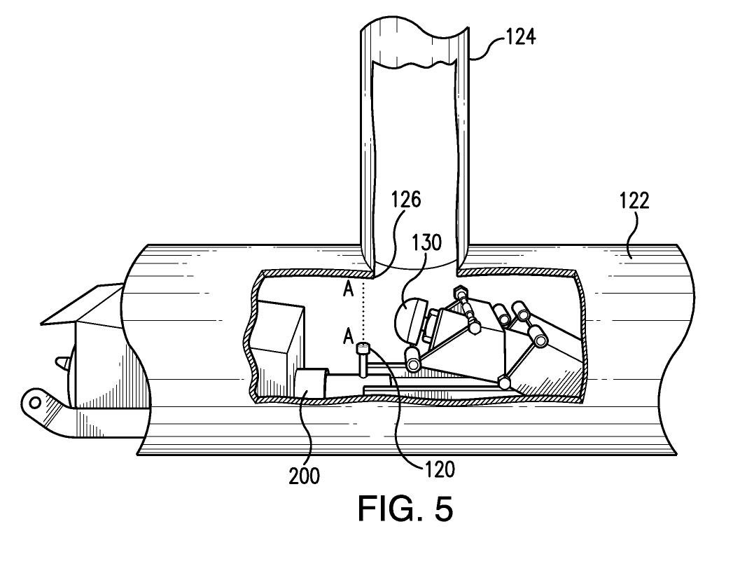

FIG. 5 illustrates yet another embodiment in which laser sighting is added to the disclosure. In this illustration, a laser sight 120 is mounted on a steering assembly 200 and positioned to shine a laser sight beam along the line A-A, in the same general direction as the tool head is oriented to rotate. By use of this laser sight 120, visual verification of the tool head location can be provided. As is seen in the cutaway junction of a major pipe 122 and minor pipe 124, a tool head 130 is beginning its upward motion and the laser sight 120 is shining the sight beam upward and toward the junction periphery 126 of the minor pipe. This provides improvement to the steering assembly 200, as its location is now verifiable.

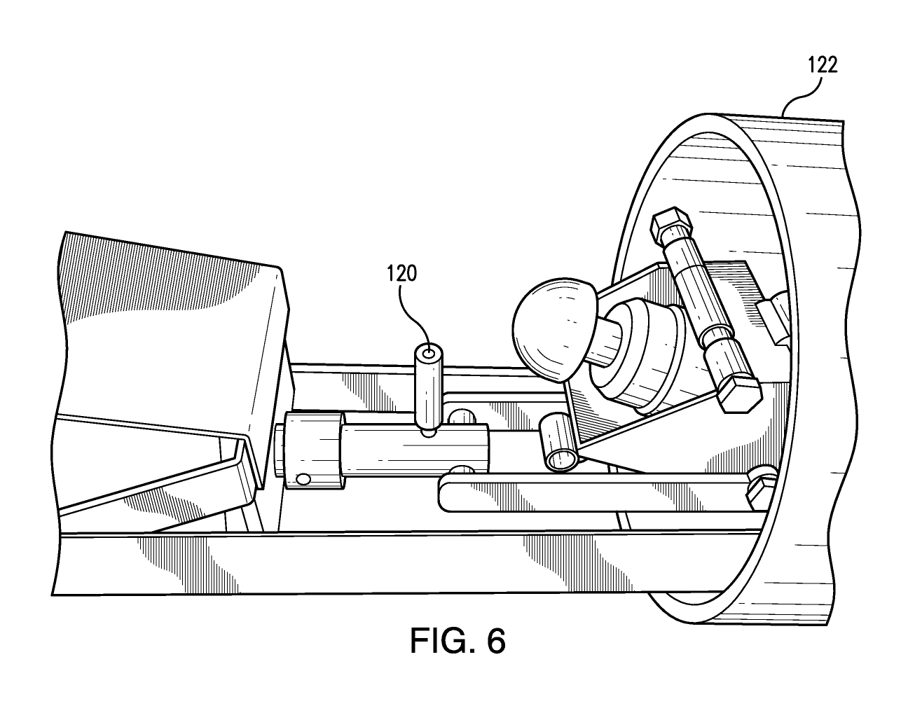

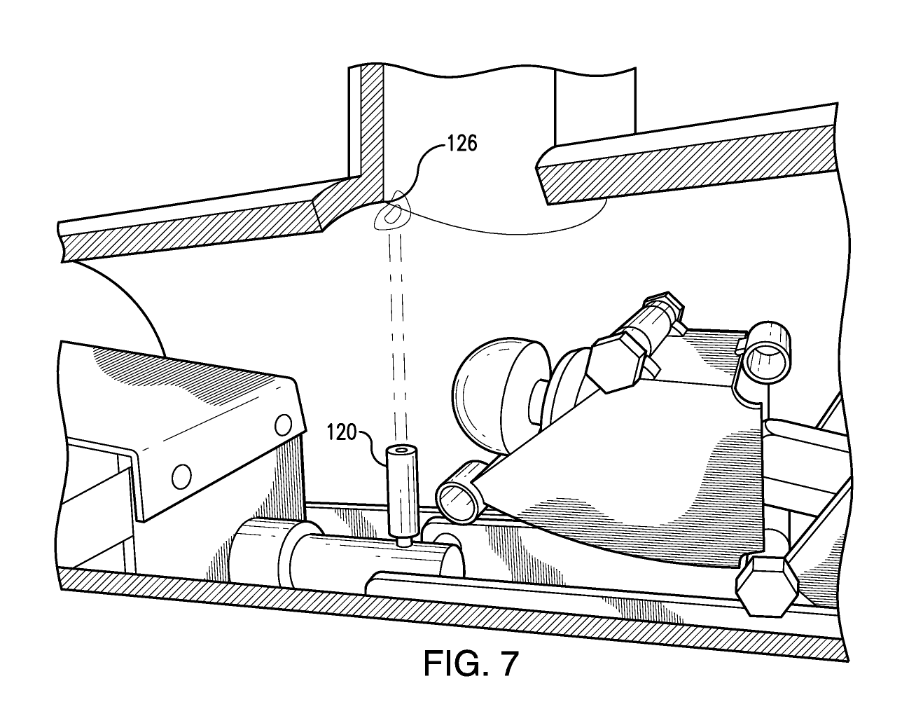

FIG. 6 shows the laser sight 120 as positioned on the steering assembly 200 as the steering assembly 200 is partially withdrawn from the major pipe 122. As shown, the laser sight 120 is mounted onto the steering assembly 200. As shown in FIG. 7, the laser sight 120 has been positioned to verify the presence of the minor pipe junction 126.

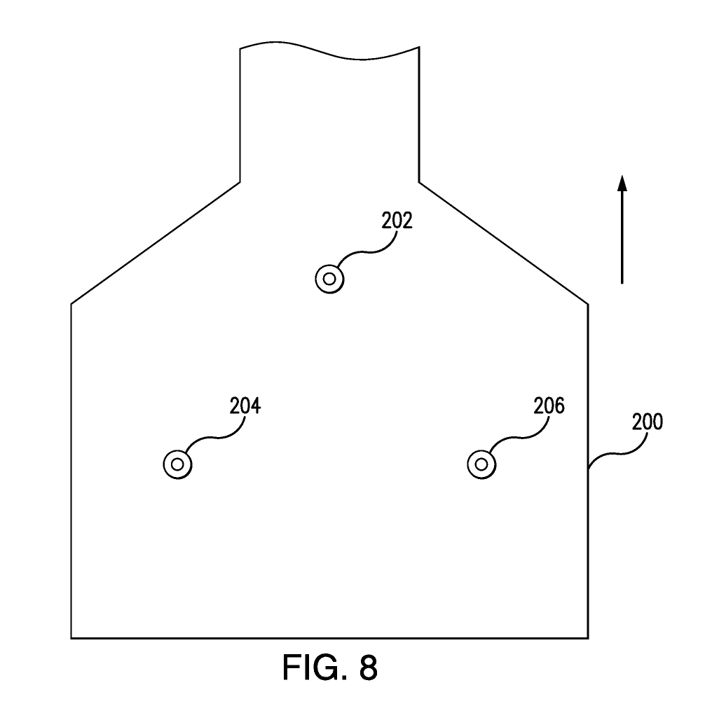

FIG. 8 is a rough schematic representation of an array of laser sights 202, 204, 206 positioned on the steering assembly 200, as anticipated in yet another embodiment of the disclosure. As the assembly 200 is moved toward the pipe to be located (in the direction of the arrow), the lead laser sight 202 locates the beginning of the pipe. Sights 204, 206, which can be moveably mounted on the assembly 200 so as to have a selectable distance apart from one another, can be used to verify the diameter of the pipe. In a most preferred application, the sights 204, 206 would be five inches apart, because most pipe diameters are 4, 5 or 6 inches in practice. Thus, the sight array could determine whether the pipe diameter was equal to, greater than or less than the preset distance, five inches, and the operator would understand that the pipe diameter is 5, 6 or 4 inches, respectively.

In another array of laser sights, a pair of lasers can be used. One laser would be mounted in fixed relation to the sled and used as a point of reference. A second laser would be fixed relative to the shoe, thereby being rotatable relative to the first laser, and would therefore assist in confirmation when locating the junction of a minor pipeline from travel throughout a major pipeline.

While reference has been made to FIGS. 1 through 8 and the accompanying text, additional details are available regarding a most preferred embodiment. For example, perspective as to the size of the components as they are ideally configured for inclusion in a nominal 8-inch sewer pipe (which may have an inner diameter of between about 7.25 and 7.5 inches) are as follows. The extension modules are sized to be between about three and four inches long.

Thus, an adaptable steering assembly for use in a pipeline having an axial pathway is disclosed. The assembly has a skid constructed and arranged to be moveable along the axial pathway, a cable-receiving terminus mounted to the skid and configured to accept a hose therethrough, a shoe member providing a hose pass-through and being rotationally secured to the cable-receiving terminus so that it can rotate axially relative to the axial pathway, and a last extension module having a forward and rearward terminus and providing a hose pass-through. The extension module rearward terminus is pivotally moveable along an axis that is substantially perpendicular to the axial pathway, whereby the forward terminus of the extension module is moveable upward away from the skid.

The steering assembly is thus constructed and arranged so that a hose can pass through the cable-receiving terminus, pass through the shoe member, pass through the extension module and present a hose-mounted tool head that is rotationally and upwardly movable relative to the skid.

Additionally, the adaptable steering assembly can be provided with a motor mounted to the skid, the motor having manual controls and being operatively associated with the shoe to rotate the shoe with respect to the cable-receiving terminus.

Additionally, the adaptable steering assembly can be configured so that the last extension module is further provided with a slot configured to receive a roller and a roller positioned within the slot to provide a friction-reducing pivot member on the last extension module.

Optionally, at least a portion of the last extension module is provided with a see-through sight-window.

In an even more preferred embodiment, the adaptable steering assembly for use in a pipeline having an axial pathway further has a laser sight mounted in fixed relation with the skid and maintained in a position forward of a hose-mounted tool head as the skid is moved along the axial pathway.

The adaptable steering assembly for use in a pipeline having an axial pathway can have between 1 and 6 serially-connected, first extension modules interposed between the shoe member and the last extension module, each first extension module having a forward and rearward terminus and providing a hose pass-through. In a more preferred embodiment, between 2 and 3 serially-connected, first extension modules are thus provided.

In a more detailed embodiment, an adaptable steering assembly for use in a pipeline having an axial pathway has a skid constructed and arranged to be moveable along the axial pathway, a cable-receiving terminus mounted to the skid and configured to accept a hose therethrough, a shoe member providing a hose pass-through and being rotationally secured to the cable-receiving terminus so that it can rotate axially relative to the axial pathway and a motor mounted to the skid, the motor having manual controls and being operatively associated with the shoe to rotate the shoe with respect to the cable-receiving terminus. A first extension module is interposed between the shoe member and a last extension module, the first extension module having a forward and rearward terminus and providing a hose pass-through. A last extension module has a forward and rearward terminus and providing a hose pass-through is provided, the last extension module rearward terminus being pivotally moveable along an axis that is substantially perpendicular to the axial pathway, whereby the forward terminus of the extension module is moveable upward away from the skid. The last extension module further has a slot configured to receive a roller and a roller positioned within the slot to provide a friction-reducing pivot member on the last extension module. A see-through sight-window is positioned on the last extension module. The steering assembly further has a laser sight mounted in fixed relation with the skid and maintained in a position forward of a hose-mounted tool head as the skid is moved along the axial pathway. Thus, the steering assembly is constructed and arranged so that a hose can pass through the cable-receiving terminus, pass through the shoe member, pass through the extension module and present a hose-mounted tool head that is rotationally and upwardly movable relative to the skid.

Still in further detail, in the adaptable steering assembly of the above paragraph, the cable-receiving terminus further has a cable funnel configured to gather a hose, communication cables and other items to be strung through the pipeline, the cable funnel being fixed in rotational orientation to the skid and communicating with an articulating junction constructed and arranged to provide rotational securement of the shoe with the cable funnel so that the shoe can be rotated but remains in communication with the cable funnel.

Even more preferably, the shoe further has two forward top bolt apertures spaced at the forward top portion of the shoe and spaced apart to provide a forward top bolt aperture spacer and two forward bottom bolt apertures spaced apart to provide a forward bottom bolt aperture spacer. The first extension module has a single rearward top bolt aperture and a single rearward bottom bolt aperture, configured for communication with the two forward top bolt apertures spaced at the forward top portion of the shoe and the two forward bottom bolt apertures spaced apart; thereby providing a bolt passageway configured to receive a bolt for securement of the shoe to the first extension module.

Additionally, the first extension module can have two forward top bolt apertures spaced at the forward top portion of the module and spaced apart to provide a forward top bolt aperture spacer, and two forward bottom bolt apertures spaced apart to provide a forward bottom bolt aperture spacer. The last extension module has two forward top bolt apertures spaced at the forward top portion of the module and spaced apart to provide a forward top bolt aperture spacer, and two forward bottom bolt apertures spaced apart to provide a forward bottom bolt aperture spacer. The last extension module further having a single rearward top bolt aperture and a single rearward bottom bolt aperture, configured for communication with the first extension module. The aperture spacer for the last extension module providing a slot configured to receive a roller on the back and front thereof.

More preferably, there are between 2 and 3 serially connected first extension modules. The laser sight further comprises an array of three laser sights, configured to provide data pertaining to when the tool head first encounters a junction with a minor pipe, is approximately centered along the junction with the minor pipe and is passing through the junction with the minor pipe, respectively. Most preferably, the first and last extension modules are between three and four inches long.

As thus configured, in the preferred embodiment thus described, the modules are positioned so that the bolt apertures communicate with the spacers, thereby interlocking the pieces in a lateral direction and defining a bolt-receiving passageway configured to receive a bolt to be secured by a nut. On the last module, the top bolt apertures are provided not only with a bolt but with a collar overlaying the bolt and positioned within the aperture spacer, thereby providing a friction reducing pivot member so that a hose can pivot outwardly around the bolt/collar assembly, rather than impinging upon the junction of a minor pipe and a major pipe.

In an alternative embodiment, an adaptable steering assembly for use in a pipeline having an axial pathway provides a clear, flexible hose. The hose is provided with a notch in the lower portion at a predetermined distance from the conduit terminus, thereby facilitating an upward bending flex as a hose head reaches the junction of a minor pipe with a major pipe. A pin is positioned opposite the notch and secured to the hose.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

What is claimed is:

1. An adaptable steering assembly for use in a pipeline having an axial pathway comprising:
a skid constructed and arranged to be moveable along the axial pathway;
a cable-receiving terminus mounted to the skid and configured to accept a hose therethrough;
a shoe member providing a hose pass-through and being rotationally secured to the cable-receiving terminus so that it can rotate axially relative to the axial pathway;
a last extension module having a forward and rearward terminus and providing a hose pass-through, the extension module rearward terminus being pivotally moveable along an axis that is substantially perpendicular to the axial pathway, whereby the forward terminus of the extension module is moveable upward away from the skid;
the steering assembly being constructed and arranged so that a hose can pass through the cable-receiving terminus, pass through the shoe member, pass through the extension module and present a hose-mounted tool head that is rotationally and upwardly movable relative to the skid.

2. The adaptable steering assembly for use in a pipeline having an axial pathway of claim 1, further comprising a motor mounted to the skid, the motor having manual controls and being operatively associated with the shoe to rotate the shoe with respect to the cable-receiving terminus.

3. The adaptable steering assembly for use in a pipeline having an axial pathway of claim 1, wherein the last extension module is further provided with a slot configured to receive a roller and a roller positioned within the slot to provide a friction-reducing pivot member on the last extension module.

4. The adaptable steering assembly for use in a pipeline having an axial pathway of claim 1, wherein at least a portion of the last extension module is provided with a see-through sight-window.

5. The adaptable steering assembly for use in a pipeline having an axial pathway of claim 1, the steering assembly further having a laser sight mounted in fixed relation with the skid and maintained in a position forward of a hose-mounted tool head as the skid is moved along the axial pathway.

6. The adaptable steering assembly for use in a pipeline having an axial pathway of claim 1, further comprising N, serially-connected first extension modules interposed between the shoe member and the last extension module, each first extension module having a forward and rearward terminus and providing a hose pass-through.

7. The adaptable steering assembly for use in a pipeline having an axial pathway of claim 6, wherein N is between 1 and 6.

8. The adaptable steering assembly for use in a pipeline having an axial pathway of claim 7, wherein N is between 2 and 3.

9. An adaptable steering assembly for use in a pipeline having an axial pathway comprising:
a skid constructed and arranged to be moveable along the axial pathway;
a cable-receiving terminus mounted to the skid and configured to accept a hose therethrough;
a shoe member providing a hose pass-through and being rotationally secured to the cable-receiving terminus so that it can rotate axially relative to the axial pathway;
a motor mounted to the skid, the motor having manual controls and being operatively associated with the shoe to rotate the shoe with respect to the cable-receiving terminus;
a first extension module interposed between the shoe member and a last extension module, the first extension module having a forward and rearward terminus and providing a hose pass-through;
a last extension module having a forward and rearward terminus and providing a hose pass-through, the last extension module rearward terminus being pivotally moveable along an axis that is substantially perpendicular to the axial pathway, whereby the forward terminus of the extension module is moveable upward away from the skid;
the last extension module further having a slot configured to receive a roller and a roller positioned within the slot to provide a friction-reducing pivot member on the last extension module;
a see-through sight-window positioned on the last extension module;
the steering assembly further having a laser sight mounted in fixed relation with the skid and maintained in a position forward of a hose-mounted tool head as the skid is moved along the axial pathway;
the steering assembly being constructed and arranged so that a hose can pass through the cable-receiving terminus, pass through the shoe member, pass through the extension module and present a hose-mounted tool head that is rotationally and upwardly movable relative to the skid.

10. The adaptable steering assembly for use in a pipeline having an axial pathway of claim 9, wherein the cable-receiving terminus further comprises a cable funnel configured to gather a hose, communication cables and other items to be strung through the pipeline, the cable funnel being fixed in rotational orientation to the skid and communicating with an articulating junction constructed and arranged to provide rotational securement of the shoe with the cable funnel so that the shoe can be rotated but remains in communication with the cable funnel.

11. The adaptable steering assembly for use in a pipeline having an axial pathway of claim 9, wherein:
the shoe further comprises two forward top bolt apertures spaced at the forward top portion of the shoe and spaced apart to provide a forward top bolt aperture spacer and two forward bottom bolt apertures spaced apart to provide a forward bottom bolt aperture spacer;
the first extension module has a single rearward top bolt aperture and a single rearward bottom bolt aperture, configured for communication with the two forward top bolt apertures spaced at the forward top portion of the shoe and the two forward bottom bolt apertures spaced apart; thereby providing a bolt passageway configured to receive a bolt for securement of the shoe to the first extension module.

12. The adaptable steering assembly for use in a pipeline having an axial pathway of claim 9, wherein:
the first extension module comprises two forward top bolt apertures spaced at the forward top portion of the module and spaced apart to provide a forward top bolt aperture spacer, and two forward bottom bolt apertures spaced apart to provide a forward bottom bolt aperture spacer; and
the last extension module having two forward top bolt apertures spaced at the forward top portion of the module and spaced apart to provide a forward top bolt aperture spacer, and two forward bottom bolt apertures spaced apart to provide a forward bottom bolt aperture spacer;
the last extension module further having a single rearward top bolt aperture and a single rearward bottom bolt aperture, configured for communication with the first extension module;
the bolt apertures for the last extension module providing a slot configured to receive a roller on the back and front thereof.

13. The adaptable steering assembly for use in a pipeline having an axial pathway of claim 9, wherein there are between 2 and 3 serially connected first extension modules.

14. The adaptable steering assembly for use in a pipeline having an axial pathway of claim 9, wherein the laser sight further comprises an array of three laser sights, configured to provide data pertaining to when the tool head first encounters a junction with a minor pipe, is approximately centered along the junction with the minor pipe and is passing through the junction with the minor pipe, respectively.

15. The adaptable steering assembly for use in a pipeline having an axial pathway of claim 9, wherein the first and last extension modules are between three and four inches long.

16. The adaptable steering assembly for use in a pipeline having an axial pathway of claim 9, wherein the cable-receiving terminus further comprises a cable funnel configured to gather a hose, communication cables and other items to be strung through the pipe, the cable funnel being fixed in rotational orientation to the skid and communicating with an articulating junction constructed and arranged to provide rotational securement of the shoe with the cable funnel so that the shoe can be rotated but remains in fluid communication with the cable funnel;
the shoe further comprises two forward top bolt apertures spaced at the forward top portion of the shoe and spaced apart to provide a forward top bolt aperture spacer and two forward bottom bolt apertures spaced apart to provide a forward bottom bolt aperture spacer;
the first extension module has a single rearward top bolt aperture and a single rearward bottom bolt aperture, configured for communication with the two forward top bolt apertures spaced at the forward top portion of the shoe and the two forward bottom bolt apertures spaced apart; thereby providing a bolt passageway configured to receive a bolt for securement of the shoe to the first extension module;
the first extension module comprises two forward top bolt apertures spaced at the forward top portion of the module and spaced apart to provide a forward top bolt aperture spacer, and two forward bottom bolt apertures spaced apart to provide a forward bottom bolt aperture spacer;
the last extension module having two forward top bolt apertures spaced at the forward top portion of the module and spaced apart to provide a forward top bolt aperture spacer, and two forward bottom bolt apertures spaced apart to provide a forward bottom bolt aperture spacer;
the last extension module further having a single rearward top bolt aperture and a single rearward bottom bolt aperture, configured for communication with the first extension module;
the bolt apertures for the last extension module providing a slot configured to receive a roller on the back and front thereof;
whereby the modules are positioned so that the bolt apertures communicate with the spacers, thereby interlocking the pieces in a lateral direction and defining a bolt-receiving passageway configured to receive a bolt to be secured by a nut; and
whereby on the last module, the top bolt apertures are provided not only with a bolt but with a collar overlaying the bolt and positioned within the aperture spacer, thereby providing a friction reducing pivot member so that a hose can pivot outwardly around the bolt/collar assembly, rather than impinging upon the junction of a minor pipe and a major pipe.

17. The adaptable steering assembly for use in a pipeline having an axial pathway of claim 16, wherein the laser sight further comprises an array of three laser sights, configured to provide data pertaining to when the tool head first encounters a junction with a minor pipe, is approximately centered along the junction with the minor pipe and is passing through the junction with the minor pipe, respectively.

18. The adaptable steering assembly for use in a pipeline having an axial pathway of claim 16, wherein the first and last extension modules are between three and four inches long.

19. The adaptable steering assembly for use in a pipeline having an axial pathway of claim 17, wherein the first and last extension modules are between three and four inches long.

20. An adaptable steering assembly for use in a pipeline having an axial pathway comprising:
a clear, flexible hose, the hose provided with a notch in the lower portion at a predetermined distance from the conduit terminus, thereby facilitating an upward bending flex as a hose head reaches the junction of a minor pipe with a major pipe; and
a pin positioned opposite the notch and secured to the hose.
